(19) United States
(12) Patent Application Publication
(10) Pub. No.: US 2019/0378494 A1
(43) Pub. Date: Dec. 12, 2019

(54) METHOD AND APPARATUS FOR OUTPUTTING INFORMATION

(71) Applicant: Baidu Online Network Technology (Beijing) Co., Ltd., Beijing (CN)

(72) Inventor: Zaipeng Hou, Beijing (CN)

(21) Appl. No.: 16/298,714

(22) Filed: Mar. 11, 2019

(30) Foreign Application Priority Data
Jun. 8, 2018 (CN) 201810589033.2

(51) Int. Cl. G10L 15/07; G10L 15/08; H04N 21/422; H04N 21/81; G10L 15/22

(52) U.S. Cl. CPC G10L 15/07; G10L 15/083; G10L 2015/223; H04N 21/8133; G10L 15/22; H04N 21/42203

(57) ABSTRACT

Embodiments of the present disclosure disclose a method and apparatus for outputting information. A specific embodiment of the method comprises: receiving a message of requesting to enter a target user mode, the message being inputted by a first user; determining identity information of the first user; determining whether the target user mode matches the identity information of the first user; and selecting, if the target user mode matches the identity information, an operation option page matching the target user mode from a preset operation option page set, to output the operation option page. According to the embodiment, a personalized operation option page can be provided for a smart television user of a different type.

### CROSS-REFERENCE TO RELATED APPLICATIONS

This application claims priority to Chinese Patent Application No. 201810589033.2, filed on Jun. 8, 2018, titled “Method and Apparatus for Outputting Information,” which is hereby incorporated by reference in its entirety.

### TECHNICAL FIELD

The present disclosure relates to the field of smart television technology, and specifically to a method and apparatus for outputting information.

### BACKGROUND

Smart televisions have been widespread in our lives. The smart televisions are not only limited to traditional television program viewing functions. At present, the popular television application market provides thousands of television applications for users, covering television live streaming, video-on-demand, stock and finance, healthy life, system optimization tool, etc.

In the existing technology, the smart televisions have numerous functions, and present the same complicated operation interface to different user groups.

### SUMMARY

Embodiments of the present disclosure provide a method and apparatus for outputting information.

In a first aspect, the embodiments of the present disclosure provide a method for outputting information. The method includes: receiving a message of requesting to enter a target user mode, the message being inputted by a first user; determining identity information of the first user; determining whether the target user mode matches the identity information of the first user; and selecting, if the target user mode matches the identity information, an operation option page matching the target user mode from a preset operation option page set, to output the operation option page.

In some embodiments, the method further includes: selecting, if the target user mode does not match the identity information, an operation option page matching a user mode matching the identity information of the first user from the preset operation option page set, to output the operation option page.

In some embodiments, the determining identity information of the first user includes: in response to receiving first voice of the first user, generating a first voiceprint characteristic vector based on the first voice; and inputting the first voiceprint characteristic vector into a pre-trained voiceprint recognition model to obtain the identity information of the first user, the recognition model being used to represent a corresponding relationship between the voiceprint characteristic vector and the identity information of the user.

In some embodiments, the determining identity information of the first user includes: outputting a question for verifying user identity information; determining, in response to receiving reply information inputted by the first user, whether an answer matching the reply information is included in a predetermined answer set, the answer corresponding to the user identity information; and determining, if the answer is included in the predetermined answer set, the user identity information corresponding to the answer matching the reply information as the identity information of the first user.

In some embodiments, the generating a first voiceprint characteristic vector based on the first voice includes: importing the first voice into a pre-trained universal background model to perform mapping to obtain a first voiceprint characteristic super-vector, the universal background model being used to represent a corresponding relationship between voice and the voiceprint characteristic super-vector; and performing a dimension reduction on the first voiceprint characteristic super-vector to obtain the first voiceprint characteristic vector.

In some embodiments, the method further includes: recording, in response to determining the first user belonging to a predetermined population group according to the identity information of the first user, a time point of determining the identity information of the first user as a viewing start time of the first user; and outputting time prompting information or performing a turnoff operation, in response to determining at least one of a difference between a current time and the viewing start time of the first user being greater than a viewing duration threshold of the predetermined population group or the current time being within a predetermined time interval.

In some embodiments, the identity information includes at least one of: gender, age or family member identifier.

In some embodiments, the method further includes: in response to receiving second voice of a second user, generating a second voiceprint characteristic vector based on the second voice; inputting the second voiceprint characteristic vector into a voiceprint recognition model to obtain identity information of the second user, the recognition model being used to represent a corresponding relationship between the voiceprint characteristic vector and the identity information of the user; and determining a younger user from the first user and the second user, and selecting an operation option page matching a user mode corresponding to the younger user from the preset operation option page set to output the operation option page.

In a second aspect, the embodiments of the present disclosure provide an apparatus for outputting information. The apparatus includes: a receiving unit, configured to receive a message of requesting to enter a target user mode, the message being inputted by a first user; a determining unit, configured to determine identity information of the first user; a matching unit, configured to determine whether the target user mode matches the identity information of the first user; and an outputting unit, configured to select, if the target user mode matches the identity information, an operation option page matching the target user mode from a preset operation option page set, to output the operation option page.

In some embodiments, the outputting unit is further configured to: select, if the target user mode does not match the identity information, an operation option page matching a user mode matching the identity information of the first user from the preset operation option page set, to output the operation option page.

In some embodiments, the determining unit is further configured to: generate, in response to receiving first voice of the first user, a first voiceprint characteristic vector based on the first voice; and input the first voiceprint characteristic vector into a pre-trained voiceprint recognition model to obtain the identity information of the first user, the recognition model being used to represent a corresponding relationship between the voiceprint characteristic vector and the identity information of the user.

In some embodiments, determining the identity information of the first user includes: outputting a question for verifying user identity information; determining, in response to receiving reply information inputted by the first user, whether an answer matching the reply information is included in a predetermined answer set, the answer corresponding to the user identity information; and determining, if the answer is included in the predetermined answer set, the user identity information corresponding to the answer matching the reply information as the identity information of the first user.

In some embodiments, generating the first voiceprint characteristic vector based on the first voice includes: importing the first voice into a pre-trained universal background model to perform mapping to obtain a first voiceprint characteristic super-vector, the universal background model being used to represent a corresponding relationship between voice and the voiceprint characteristic super-vector; and performing a dimension reduction on the first voiceprint characteristic super-vector to obtain the first voiceprint characteristic vector.

In some embodiments, the apparatus further includes a prompting unit. The prompting unit is configured to: record, in response to determining the first user belonging to a predetermined population group according to the identity information of the first user, a time point of determining the identity information of the first user as a viewing start time of the first user; and output time prompting information or perform a turnoff operation, in response to determining at least one of a difference between a current time and the viewing start time of the first user being greater than a viewing duration threshold of the predetermined population group or the current time being within a predetermined time interval.

In some embodiments, the identity information includes at least one of: gender, age or family member identifier.

In some embodiments, the apparatus further includes a switching unit. The switching unit is configured to: generate, in response to receiving second voice of a second user, a second voiceprint characteristic vector based on the second voice; input the second voiceprint characteristic vector into a voiceprint recognition model to obtain identity information of the second user, the recognition model being used to represent a corresponding relationship between the voiceprint characteristic vector and the identity information of the user; and determine a younger user from the first user and the second user, and select an operation option page matching a user mode corresponding to the younger user from the preset operation option page set to output the operation option page.

In a third aspect, the embodiments of the present disclosure provide an electronic device. The electronic device includes: one or more processors; and a storage device, configured to store one or more programs. The one or more programs, when executed by the one or more processors, cause the one or more processors to implement the method described in any implementation in the first aspect.

In a fourth aspect, the embodiments of the present disclosure provide a computer readable medium storing a computer program. The program, when executed by a processor, implements the method described in any implementation in the first aspect.

According to the method and apparatus for outputting information provided by the embodiments of the present disclosure, after the message of entering the target user mode is received, whether the user is permitted to enter the target user mode is determined by determining the identity information of the user. If the user is permitted, the operation option page is selected according to the target user mode to be outputted. Accordingly, a personalized operation option page can be provided for a smart television user of a different type.

### BRIEF DESCRIPTION OF THE DRAWINGS

After reading detailed descriptions of non-limiting embodiments given with reference to the following accompanying drawings, other features, objectives and advantages of the present disclosure will be more apparent:

FIG. 1 is a diagram of an exemplary system architecture in which an embodiment of the present disclosure may be applied;

FIG. 2 is a flowchart of an embodiment of a method for outputting information according to the present disclosure;

FIG. 3 is a schematic diagram of an application scenario of the method for outputting information according to the present disclosure;

FIG. 4 is a flowchart of another embodiment of the method for outputting information according to the present disclosure;

FIG. 5 is a schematic structural diagram of an embodiment of an apparatus for outputting information according to the present disclosure; and

FIG. 6 is a schematic structural diagram of a computer system adapted to implement an electronic device according to the embodiments of the present disclosure.

### DETAILED DESCRIPTION OF EMBODIMENTS

The present disclosure will be further described below in detail in combination with the accompanying drawings and the embodiments. It should be appreciated that the specific embodiments described herein are merely used for explaining the relevant invention, rather than limiting the disclosure. In addition, it should be noted that, for the ease of description, only the parts related to the relevant invention are shown in the accompanying drawings.

It should also be noted that the embodiments in the present disclosure and the features in the embodiments may be combined with each other on a non-conflict basis. The present disclosure will be described below in detail with reference to the accompanying drawings and in combination with the embodiments.

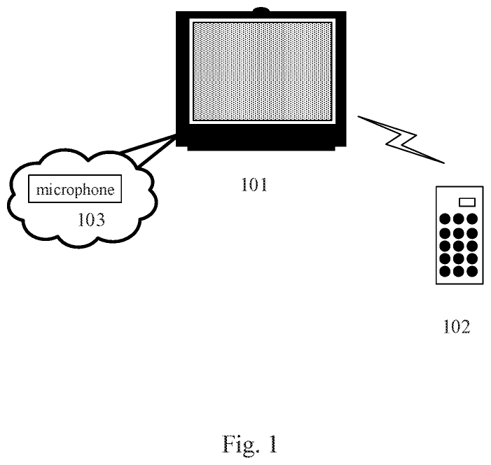

FIG. 1 shows an exemplary system architecture 100 in which an embodiment of a method for playing a television program or an apparatus for playing a television program according to the present disclosure may be applied.

As shown in FIG. 1, the system architecture 100 may include a smart television 101 and a remote control 102. The smart television 101 is provided with a microphone 103 to collect the sound of a viewer. The remote control 102 is used to remotely control the smart television 101. Thus, functions such as a conversion for a channel of a smart television and playing of a television program may be realized. After connecting to a network, the smart television 101 can provide various entertainment, information and learning resources such as a web browser, a full high definition 3D somatic game, a video call and an online education. In addition, the smart television 101 may be extended infinitely, and can respectively support tens of thousands of pieces of utility functional software developed independently and shared together by organizations and individuals, and professional and amateur software lovers. Thus, the smart television may realize various application services such as a network search, a network television, video-on-demand, a digital music, online news, and a network video call. Through the smart television, a user may search for a television channel and a website and record a television program, and may play a satellite program, a cable television program and an online video.

Like a smart phone, the smart television 101 has a fully open platform and is equipped with an operating system, on which the user may install and uninstall a program provided by a third party service provider such as software or a game. Through such program, the user may continuously extend the functions of a color television, and surf the Internet through a network cable or a wireless network. The smart television 101 may collect the sound of the viewer through the microphone 103, and then recognize the identity of the viewer. Further, the smart television 101 provides a different operating interface and different content for a different identity.

It should be noted that the method for outputting information provided in the embodiments of the present disclosure is generally performed by the smart television 101. Correspondingly, the apparatus for outputting information is generally provided in the smart television 101.

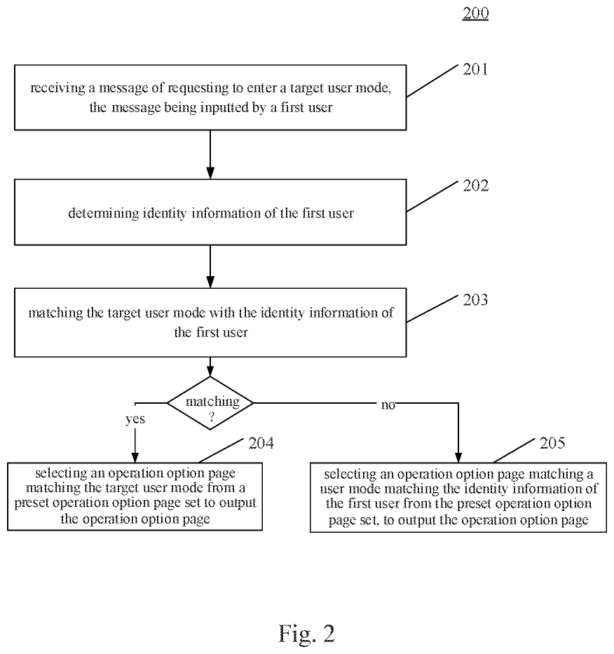

Further referring to FIG. 2, FIG. 2 illustrates a flow 200 of an embodiment of a method for outputting information according to the present disclosure. The method for outputting information includes the following steps 201 to 203.

Step 201 includes receiving a message of requesting to enter a target user mode, the message being inputted by a first user.

In this embodiment, a performing subject (e.g., the smart television shown in FIG. 1) of the method for outputting information may receive the voice of entering the target user mode verbally inputted by the user through a microphone, for example, “entering the child mode.” Alternatively, the performing subject may receive the message of requesting to enter the target user mode sent by the user through a remote control. A user mode may be a mode of an operation option page distinguished according to the age of a user, for example, an elderly mode, the child mode, and an adult mode. The target user mode may be a user mode requested by the user, for example, one of the elderly mode, the child mode, and the adult mode. The operation option page is a page for operating the smart television, the page being displayed on the home page of the smart television. The operation option page of the elderly mode may omit some options such as a game option. The operation option page of the elderly mode may also include some specific options such as a Chinese opera channel and a square dance channel. The elderly mode may also enlarge the font of the operation option page, thereby facilitating the elderly to watch. The child mode may filter out some programs that are not suitable for children to watch, set an eye protection mode, and control a volume and a viewing time. In addition, the child mode may also display phonetic symbols on the operation option page for facilitating use by aa child who is unable to read words. Moreover, the child mode may also add some cartoon images to the page to facilitate the child recognizing the operation options.

Step 202 includes determining identity information of the first user.

In this embodiment, the identity information of the user may be determined by a voice recognition or by inputting by the user an identity identifier through the remote control. The identity information may include family member identifiers such as father, mother, grandfather, grandmother, and daughter. The identity information may also include categories such as child, adult, and elderly. This step is used to determine the identity information of the user requesting to enter the target user mode. An adult may help a child to request to enter the child mode. The child cannot select to enter the adult mode by himself.

In some alternative implementations of this embodiment, the determining identity information of the first user may include the following steps 202A1 and 202A2.

Step 202A1 includes in response to receiving first voice of the first user, generating a first voiceprint characteristic vector based on the first voice.

Since there may be a plurality of users using the smart television, the first user and a second user are used to distinguish the users. The voice inputted by the first user is referred to as the first voice. The voice inputted by the second user is referred to as second voice. The processing process for the first voice and the processing process for the second voice are the same. Thus, for convenience of description, hereafter, voice is uniformly used to represent the first voice and the second voice. The voice inputted verbally by the user may be received through the microphone. The voice may include a remote control instruction (e.g., “turning on”) or instruction other than the remote control instruction. A voiceprint is an acoustic wave spectrum carrying verbal information and displayed by an electro-acoustic instrument. Modern scientific research suggests that the voiceprint not only has a specificity, but also has a relatively stable characteristic. The voiceprint characteristic vector may be a vector identifying a characteristic of the acoustic wave spectrum of the user. If a piece of audio includes sounds of a plurality of people, a plurality of voiceprint characteristic vectors may be extracted. It should be noted that generating the voiceprint characteristic vector based on the voice is a publicly known technique widely studied and applied at present, which will not be repeatedly described herein.

For example, the generating the voiceprint characteristic vector based on the voice may be implemented by extracting a typical feature in the voice. Specifically, features of the sound such as a wavelength, a frequency, an intensity, and a rhythm can reflect the characteristics of the sound of the user. Therefore, when the voiceprint characteristic extraction is performed on the voice, the features in the sound such as the wavelength, the frequency, the intensity, and the rhythm may be extracted, and the feature values of the features such as the wavelength, the frequency, the intensity, and the rhythm in the voice may be determined. The feature values of the features such as the wavelength, the frequency, the intensity, and the rhythm in the voice are used as elements in the voiceprint characteristic vector.

As an example, the generating the voiceprint characteristic vector based on the voice may also be implemented by extracting an acoustic feature in the voice, for example, a Mel-frequency cepstral coefficient. The Mel-frequency cepstral coefficient is used as an element in the voiceprint characteristic vector. The process of extracting the Mel cepstral coefficient from the voice may include a pre-emphasis, framing, windowing, a fast Fourier transform, Mel filtering, a logarithmic transformation, and a discrete cosine transform.

Before inputting the voice, the user may make the smart television muted through the remote control, to keep the collected voice inputted by the user from including the sound of a television program. Alternatively, the smart television may also be muted by a predetermined voice command. For example, the user may verbally input “silent” to make the smart television muted.

In some alternative implementations of this embodiment, an electronic device may import the voice into a pre-trained universal background model (UBM) to perform mapping to obtain a voiceprint characteristic super-vector (i.e., a Gaussian super-vector). The universal background model is also referred to as a global background model for representing a general background characteristic. The universal background model is obtained by performing training on voices of a large number of impostors using an EM (Expectation-Maximum) algorithm. The training for the UBM model is from a large number of different speakers. It is assumed that there are a plurality of Gaussian distributions in the trained universal background model. If a plurality of frames of voice characteristic sequences of a certain speaker are extracted, the voiceprint characteristic super-vector of the speaker may be calculated. In fact, the difference between the acoustic characteristic of the speaker and the universal background model is reflected. That is, the unique individuality in the pronunciation of the speaker is reflected. Thus, the voice of the user having an uncertain length may be finally mapped onto a voiceprint characteristic super-vector having a fixed length that can reflect the vocalization characteristic of the user.

Such high-dimensional voiceprint characteristic super-vector not only includes an individual difference in pronunciation, but may also include a difference caused by a channel. Therefore, a dimension reduction is also required to be performed on the super-vector through some supervised dimension reduction algorithms, to map the super-vector onto a lower-dimensional vector. The dimension reduction may be performed on the voiceprint characteristic super-vector through a Joint Factor Analysis (JFA) method to obtain the voiceprint characteristic vector. The Joint Factor Analysis method is an effective algorithm for channel compensation in voiceprint authentication algorithms, which estimates a channel factor by assuming that a speaker space and a channel space are independent, and the speaker space and the channel space may be described by two low-dimensional factor spaces respectively. Alternatively, the dimension reduction may be performed on the voiceprint characteristic super-vector through a probabilistic linear discriminant analysis (PLDA) algorithm to obtain the voiceprint characteristic vector. The probabilistic linear discriminant analysis algorithm is also a channel compensation algorithm, which is a linear discriminant analysis (LDA) algorithm in a probabilistic form. In addition, the dimension reduction may alternatively be performed on the voiceprint characteristic super-vector through an identifying vector (I-Vector) to obtain the voiceprint characteristic vector. In fact, in order to ensure the accuracy of the voiceprint, a plurality of pieces of voice generally need to be provided for training the universal background model. Then, a plurality of voiceprint characteristic vectors of the above voice are extracted and obtained. Next, the voiceprint characteristic vector of the user may be stored, and voiceprint characteristic vectors of a plurality of users constitute a voiceprint library.

Then, the dimension reduction is performed on the voiceprint characteristic super-vector to obtain the voiceprint characteristic vector using the above method. By using a large number of acoustic characteristic vectors of many people, a Gaussian mixture model may be trained through the Expectation Maximization algorithm. This model describes a probability distribution of voice characterization data of many people, which may be understood as the commonality of all the speakers. The model is served as a priori model for a voiceprint model of a certain speaker. Therefore, this Gaussian mixture model is also referred to as the UBM model. The universal background model may also be constructed through a deep neural network.

Alternatively, before the voiceprint characteristic vector is generated, the voice may be processed to filter out a noise. For example, the noise in the voice is filtered out through a singular value decomposition algorithm or a filter algorithm. The noise herein may include a discordant sound having a confusing change in pitch and intensity. The noise herein may also include a sound that interferes with the recognition for a target sound, for example, background music. The singular value decomposition (SVD) is an important matrix factorization in Linear algebra, which is the generalization of the unitary diagonalization of a normal matrix in matrix analysis. The SVD has important applications in the fields of signal processing and statistics. The SVD-based de-noising technique is one of the subspace algorithms. Simply put, a noisy signal vector space is decomposed into two subspaces respectively dominated by a pure signal and a noise signal. Then, the pure signal is estimated by simply removing the noisy signal vector component in the “noise space.” The noise in an audio file may a be filtered out through an adaptive filter method and a Kalman filter method. The voice is usually framed with an interval of 20-50 ms, and then, each frame of voice may be mapped to an acoustic characteristic sequence having a fixed length by some feature extraction algorithms (mainly performing a conversion from a time domain to a frequency domain).

Step 202A2 includes inputting the first voiceprint characteristic vector into a pre-trained voiceprint recognition model to obtain the identity information of the first user.

The voiceprint recognition model is used to represent a corresponding relationship between the voiceprint characteristic vector and the identity information of the user. The identity information of the user may include at least one of: gender, age or family member identifier. The age may be a certain age range, for example, 4-8 years old, and 20-30 years old. Gender and age may be combined to determine the specific identity of the user. For example, child, elderly, adult female, and adult male may be recognized. The family member identifier may be used to identify a pre-registered family member, for example, mother, father, daughter, and grandmother. If the number of member having close ages and the same gender in the family is merely one, the family member may be directly determined using the age and the gender of the user. For example, the family members include a mother, a father, a daughter and a grandmother, it is determined that the female aged between 50 and 60 is the grandmother, and the female aged between 4 and 8 is the daughter. The voiceprint recognition model may include a classifier, which can map a voiceprint characteristic vector in the voiceprint characteristic vector library to a certain one of given categories of the user, and thus the model may be applied to the prediction for the category of the user. The classification may be performed based on the age, the gender, or a combination of the age and the gender, for example, girl, male adult, and female elderly. That is, the category of the user may be outputted by inputting the voiceprint characteristic vector into the classifier. The classifier used in this embodiment may include a decision tree, a logistic regression, a naive Bayes, a neural network, etc. Based on a simple probability model, the classifier uses the largest probability value to perform a classification prediction on the data. The classifier is trained in advance. The classifier may be trained by extracting a voiceprint characteristic vector from a large number of sound samples. In general, the configuration and the implementation for the classifier may include: 1) selecting samples (including a positive sample and a negative sample), all the samples being divided into a training sample and a test sample; 2) performing a classifier algorithm based on the training sample, to generate the classifier; 3) inputting the test sample into the classifier to generate a prediction result; and 4) calculating a necessary evaluation index according to the prediction result, to evaluate a performance of the classifier.

For example, sounds of a large number of children are collected as the positive sample, and sounds of a large number of adults are collected as the negative sample. Based on the positive sample and the negative sample, the classifier algorithm is performed to generate the classifier. Then, the positive sample and the negative sample are respectively inputted into the classifier, to generate the prediction result to verify whether the result is child. The performance of the classifier is evaluated according to the prediction result.

The voiceprint recognition model may further include a family member mapping table. The family member mapping table records a corresponding relationship between the family member identifier, the gender, and the age. The family member identifier may be determined by retrieving the classification result of the classifier from the family member mapping table. For example, if the result outputted by the classifier is a female aged between 50 and 60, the family member identifier of this user is determined as the grandmother through the family member mapping table.

Alternatively, the voiceprint recognition model may be the voiceprint library. The voiceprint library is used to represent a corresponding relationship between the voiceprint characteristic vector and the identity information. The voiceprint characteristic vector is inputted into a predetermined voiceprint library to perform matching, and a first predetermined number of pieces of identity information are selected based on a descending order of matching degrees and outputted. By collecting the sound of a given user a plurality of times, the voiceprint characteristic vector of the user may be constructed through step 201, and then, the corresponding relationship between the voiceprint characteristic vector and the identity information is established. The voiceprint library is constructed by registering corresponding relationships between the voiceprint characteristic vectors of a plurality of users and the identity information of the users. The matching degree between the above voiceprint characteristic vector and the above voiceprint library may be calculated using a Manhattan distance, Minkowski distance, or a cosine similarity.

In some alternative implementations of this embodiment, determining the identity information of the first user may include the following steps 202B1 to 202B3.

Step 202B1 includes outputting a question for verifying user identity information. The question is mainly used to prevent a child from pretending to be an adult. Therefore, the question may be set as a question difficult for the child to answer, for example, “please input the mode switching password” is displayed on the television screen, or “please input the mode switching password” is prompted by voice. In order to keep the child from remembering the password, the question may alternatively be randomly generated. For example, an English question, a mathematic question, or an ancient poetry question may be set to ask the user to give an answer. The user may select or directly input an answer via the remote control, or answer by voice.

Step 202B2 includes determining, in response to receiving reply information inputted by the first user, whether a predetermined answer set includes an answer matching the reply information.

The answer corresponds to the user identity information. If the question is a password question, each password corresponds to a kind of user identity information. The user may determine the user identity information according to the reply information inputted by the user. For example, the adult password is preset to “adult,” and the child password is preset to “child.” If the smart television receives “adult,” the user may be determined as an adult. If there are questions with fixed answers, the reply information inputted by the user may be compared with the fixed answers. For convenience of answering, a multiple-choice question may be provided when the question is proposed, and the user only needs to select A, B, C, or D.

Step 202B3 includes determining, if the answer is included in the predetermined answer set, the user identity information corresponding to the answer matching the reply information as the identity information of the first user.

The answer corresponds to the user identity information. Different answers correspond to different identity information. If the question is a password question, each password corresponds to a kind of user identity information. The corresponding user identity may be found according to the password answered by the user. If the question is not a password question, whether the answer is correct may be determined according to the reply information inputted by the user. If there is no answer matching the reply information in the predetermined answer set, the answer is incorrect, and the identity information of the user cannot be identified. If there is an answer matching the reply information in the predetermined answer set, the answer is correct, and the identity information of the user is determined according to the corresponding relationship between the answer and the user identity information.

Step 203 includes matching the target user mode with the identity information of the first user.

In this embodiment, each kind of identity information matches at least one user mode. For example, the adult may match the child mode, the elderly mode, and the adult mode. The elderly may match the child mode and the elderly mode. The child only matches the child mode. If the determined identity information is the child, and the target user mode requested by the user is the adult mode, the target user mode does not match the identity information. If the determined identity information is the child, and the target user mode requested by the user is the child mode, the target user mode matches the identity information. The adult may help the child or the elderly to select the target user model. Only with the help of the adult, the child can enter the adult mode, such that the child enters the adult mode under the supervision of the adult. If there is no adult supervision, the child can only enter the child mode.

Step 204 includes selecting, if the target user mode matches the identity information, an operation option page matching the target user mode from a preset operation option page set to output the operation option page.

In this embodiment, different user modes correspond to different operation option pages. If the target user mode matches the identity information, the target user mode requested by the user may be directly entered. The operation option page may include the home page of the smart television. The operation option page may alternatively include operation options in a menu form. The operation options may include a channel option, a sound option, an image option, etc. The operation option pages in the preset operation option page set are different from each other. For example, the front on the operation option page for the elderly mode is thick and big, and the number of operation options on the page is small, to avoid a too complicated operation from affecting the use of the elderly. Some channel options (e.g., a Chinese opera channel, and an advertisement channel) may be removed from the operation option page for the child mode, and the phonetic alphabet may be displayed for an under-age child to read. The operation option page for the adult mode may show all the functions supported by the smart television.

Step 205 includes selecting, if the target user mode does not match the identity information, an operation option page matching a user mode matching the identity information of the first user from the preset operation option page set, to output the operation option page.

In this embodiment, if the target user mode does not match the identity information, the target user mode requested by the user is not entered, and the user mode matching the identity information of the user is entered. For example, the identity information of the user is the child. The user requests to enter the adult mode, but since the requested user mode does not match the actual identity of the user, the user is only allowed to enter the child mode.

Alternatively, if the identity information of the user is not determined in step 202, the user may enter a predetermined guest mode. Specific permissions are set for a guest. For example, the guest cannot watch a paying program. Alternatively, the child mode is used for the guest by default.

In some alternative implementations of this embodiment, the above method may further include the following steps 2051 and 2052.

Step 2051 includes recording, in response to determining the first user belonging to a predetermined population group according to the identity information of the first user, a time point of determining the identity information of the first user as a viewing start time of the first user. The predetermined population group may be the elderly or the children. For health of the elderly or the child, the viewing duration of the elderly or the children needs to be controlled. Therefore, the time when the user starts viewing the television is recorded as the viewing start time of the user. The viewing start time may be recorded after the identity information of the first user is determined in step 202. Not only a length of time is included, but also the specific time may be monitored.

For example, the elderly or the child is not allowed to watch the television after 12 o'clock in the evening.

Step 2052 includes outputting, in response to determining a difference between a current time and the viewing start time of the first user being greater than a viewing duration threshold of the predetermined population group and/or the current time being within a predetermined time interval, time prompting information and/or performing a turnoff operation. The difference between the current time and the viewing start time of the user may be used as the viewing duration of the user. When the viewing duration exceeds the viewing duration threshold of the predetermined population group, the television program is no longer played or the television is turned off. The user may be notified of an upcoming timeout in advance in a form of text or voice. The predetermined time interval in which the predetermined population group is prohibited to watch the television may further be set, for example, the time interval from 12:00 pm to 6:00 am.

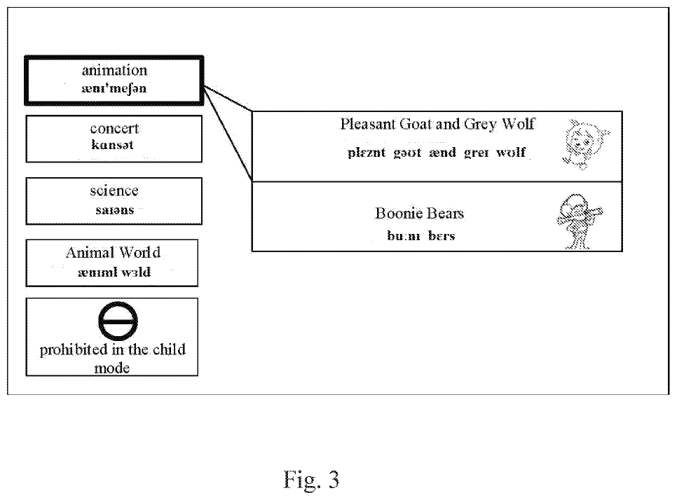

Further referring to FIG. 3, FIG. 3 is a schematic diagram of an application scenario of the method for outputting information according to this embodiment. In the application scenario of FIG. 3, the child user inputs the voice of entering the target user mode “entering the child mode” into the smart television through the microphone. The smart television extracts the voiceprint characteristic vector according to the voice “entering the child mode,” and then determines the identity information of the user as the child through the pre-trained voiceprint recognition model. Next, it is determined that the target user mode (child mode) matches the identity information of the user “child.” Thus, the operation option page corresponding to the child mode is selected from the preset set of respective operation options for the child, the adult, and the elderly, to be outputted. The operation option page in the child mode adds information such as the phonetic alphabet and a cartoon character for the usage by the child. In addition, other functions not suitable for the child are prohibited.

In the method provided by the above embodiment of the present disclosure, by verifying whether the identity information of the user matches the user mode requested by the user, the physical and mental health of the specific population group may be protected while a personalized operation option page is provided for a smart television user of a different type.

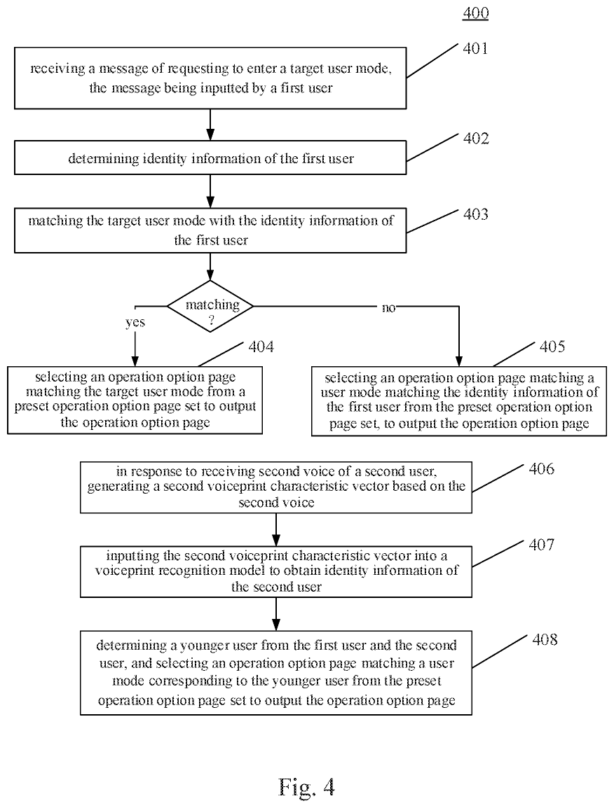

Further referring to FIG. 4, FIG. 4 illustrates a flow 400 of another embodiment of the method for outputting information. The flow 400 of the method for outputting information includes the following steps 401 to 408.

Step 401 includes: receiving a message of requesting to enter a target user mode, the message being inputted by a first user.

Step 402 includes determining identity information of the first user.

Step 403 includes matching the target user mode with the identity information of the first user.

Step 404 includes selecting, if the target user mode matches the identity information, an operation option page matching the target user mode from a preset operation option page set to output the operation option page.

Step 405 includes: selecting, if the target user mode does not match the identity information, an operation option page matching a user mode matching the identity information of the first user from the preset operation option page set, to output the operation option page.

Steps 401-405 are substantially the same as steps 201-205, which will not be repeatedly described.

Step 406 includes: in response to receiving second voice of a second user, generating a second voiceprint characteristic vector based on the second voice.

In this embodiment, there may be a plurality of users of the smart television. When the second voice of the second user is received, whether the identity information of the second user matches the current user mode may be verified. If the identity information of the second user does not match the current user mode, the user mode needs to be switched. With reference to the method in step 202A1, the second voiceprint characteristic vector may be generated based on the second voice. The specific process is substantially the same as the process of generating the first voiceprint characteristic vector based on the first voice, which will not be repeatedly described.

Step 407 includes: inputting the second voiceprint characteristic vector into a voiceprint recognition model to obtain identity information of the second user.

In this embodiment, the voiceprint recognition model is used to represent a corresponding relationship between the voiceprint characteristic vector and the identity information of the user. For this step, reference may be made to step 202A2. The specific process is substantially the same as the process of inputting the first voiceprint characteristic vector into the voiceprint recognition model to obtain the identity information of the first user, which will not be repeatedly described.

Step 408 includes: determining a younger user from the first user and the second user, and selecting an operation option page matching a user mode corresponding to the younger user from the preset operation option page set to output the operation option page.

In this embodiment, the voiceprint recognition model may recognize a general age of the user. Thereby, the operation option page matching the user mode corresponding to the younger user is selected from the preset operation option page set to be outputted. For example, if the first user is a child, even if the second user is an adult, the output is performed according to the operation option page corresponding to the child mode. The original user mode is kept, and the operation option page does not need to be switched. If the first user is the adult, the current mode is the adult mode, the mode needs to be switched to the child mode when the second user is the child.

It may be seen from FIG. 4 that, as compared with the embodiment corresponding to FIG. 2, the flow 400 of the method for outputting information in this embodiment emphasizes the step of switching the user mode. Accordingly, the solution described in this embodiment may introduce a protection for the younger user when different users are watching the television at the same time. Thus, the comprehensiveness of the protection for the child is improved.

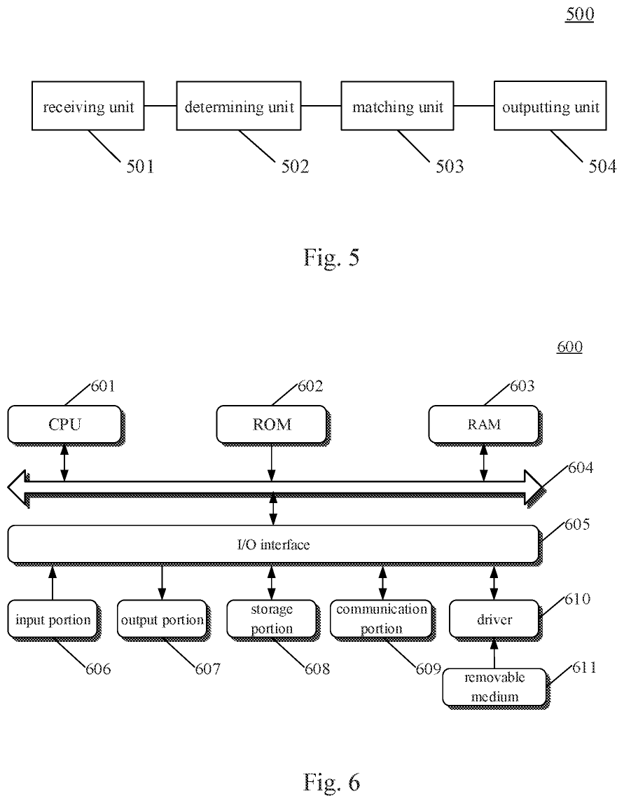

Further referring to FIG. 5, as an implementation of the method shown in the above drawings, the present disclosure provides an embodiment of an apparatus for outputting information. The embodiment of the apparatus corresponds to the embodiment of the method shown in FIG. 2, and the apparatus may be applied in various electronic devices.

As shown in FIG. 5, the apparatus 500 for outputting information in this embodiment includes: a receiving unit 501, a determining unit 502, a matching unit 503, and an outputting unit 504. The receiving unit 501 is configured to receive a message of requesting to enter a target user mode, the message being inputted by a first user. The determining unit 502 is configured to determine identity information of the first user. The matching unit is configured to determine whether the target user mode matches the identity information of the first user. The outputting unit 504 is configured to select, if the target user mode matches the identity information, an operation option page matching the target user mode from a preset operation option page set, to output the operation option page.

In this embodiment, for specific processes of the receiving unit 501, the determining unit 502, the matching unit 503, and the outputting unit 504 in the apparatus 500 for outputting information, reference may be made to step 201, step 202, step 203, and step 204 in the corresponding embodiment of FIG. 2.

In some alternative implementations of this embodiment, the outputting unit 504 is further configured to: select, if the target user mode does not match the identity information, an operation option page matching a user mode matching the identity information of the first user from the preset operation option page set, to output the operation option page.

In some alternative implementations of this embodiment, the determining unit 502 is further configured to: generate, in response to receiving first voice of the first user, a first voiceprint characteristic vector based on the first voice; and input the first voiceprint characteristic vector into a pre-trained voiceprint recognition model to obtain the identity information of the first user, the recognition model being used to represent a corresponding relationship between the voiceprint characteristic vector and the identity information of the user.

In some alternative implementations of this embodiment, the determining unit 502 is further configured to: output a question for verifying user identity information; determine, in response to receiving reply information inputted by the first user, whether a predetermined answer set includes an answer matching the reply information, the answer corresponding to the user identity information; and determine, if the answer is included in the predetermined answer set, the user identity information corresponding to the answer matching the reply information as the identity information of the first user.

In some alternative implementations of this embodiment, the determining unit 502 is further configured to: import the first voice into a pre-trained universal background model to perform mapping to obtain a first voiceprint characteristic super-vector, the universal background model being used to represent a corresponding relationship between the voice and the voiceprint characteristic super-vector; and perform a dimension reduction on the first voiceprint characteristic super-vector to obtain the first voiceprint characteristic vector.

In some alternative implementations of this embodiment, the apparatus 500 further includes a prompting unit (not shown). The prompting unit is configured to: record, in response to determining the first user belonging to a predetermined population group according to the identity information of the first user, a time point of determining the identity information of the first user as a viewing start time of the first user; and output time prompting information and/or perform a turnoff operation, in response to determining a difference between a current time and the viewing start time of the first user being greater than a viewing duration threshold of the predetermined population group and/or the current time being within a predetermined time interval.

In some alternative implementations of this embodiment, the identity information includes at least one of: gender, age or family member identifier.

In some alternative implementations of this embodiment, the apparatus 500 further includes a switching unit. The switching unit is configured to: generate, in response to receiving second voice of a second user, a second voiceprint characteristic vector based on the second voice; input the second voiceprint characteristic vector into a voiceprint recognition model to obtain identity information of the second user, the recognition model being used to represent a corresponding relationship between the voiceprint characteristic vector and the identity information of the user; and determine a younger user from the first user and the second user, and select an operation option page matching a user mode corresponding to the younger user from the preset operation option page set to output the operation option page.

Referring to FIG. 6, FIG. 6 illustrates a schematic structural diagram of a computer system 600 adapted to implement an electronic device (e.g., the smart television shown in FIG. 1) of the embodiments of the present disclosure. The electronic device shown in FIG. 6 is merely an example and should not impose any restriction on the function and scope of use of the embodiments of the present disclosure.

As shown in FIG. 6, the computer system 600 includes a central processing unit (CPU) 601, which may execute various appropriate actions and processes in accordance with a program stored in a read-only memory (ROM) 602 or a program loaded into a random access memory (RAM) 603 from a storage portion 608. The RAM 603 further stores various programs and data required by operations of the system 600. The CPU 601, the ROM 602 and the RAM 603 are connected to each other via a bus 604. An input/output (I/O) interface 605 is also connected to the bus 604.

The following components are connected to the I/O interface 605: an input portion 606 including a keyboard, a mouse. etc.; an output portion 607 including a cathode ray tube (CRT), a liquid crystal display device (LCD), a speaker, etc.; a storage portion 608 including a hard disk and the like; and a communication portion 609 including a network interface card, for example, a LAN card and a modem. The communication portion 609 performs communication processes via a network such as the Internet. A driver 610 is also connected to the I/O interface 605 as required. A removable medium 611, for example, a magnetic disk, an optical disk, a magneto-optical disk, and a semiconductor memory, may be installed on the driver 610, to facilitate the installation of a computer program from the removable medium 611 on the storage portion 608 as needed.

In particular, according to the embodiments of the present disclosure, the process described above with reference to the flowchart may be implemented as a computer software program. For example, an embodiment of the present disclosure includes a computer program product, including a computer program hosted on a computer readable medium, the computer program including program codes for performing the method as illustrated in the flowchart. In such an embodiment, the computer program may be downloaded and installed from a network via the communication portion 609, and/or may be installed from the removable medium 611. The computer program, when executed by the central processing unit (CPU) 601, implements the above mentioned functionalities as defined by the method of the present disclosure. It should be noted that the computer readable medium in the present disclosure may be a computer readable signal medium, a computer readable storage medium, or any combination of the two. For example, the computer readable storage medium may be, but not limited to: an electronic, magnetic, optical, electromagnetic, infrared, or semiconductor system, apparatus, or element, or any combination of the above. A more specific example of the computer readable storage medium may include, but not limited to: an electrical connection having one or more wires, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In the present disclosure, the computer readable storage medium may be any physical medium containing or storing programs, which may be used by a command execution system, apparatus or element or incorporated thereto. In the present disclosure, the computer readable signal medium may include a data signal that is propagated in a baseband or as a part of a carrier wave, which carries computer readable program codes. Such propagated data signal may be in various forms, including, but not limited to, an electromagnetic signal, an optical signal, or any suitable combination of the above. The computer readable signal medium may also be any computer readable medium other than the computer readable storage medium. The computer readable medium is capable of transmitting, propagating or transferring programs for use by, or used in combination with, a command execution system, apparatus or element. The program codes contained on the computer readable medium may be transmitted with any suitable medium including, but not limited to, wireless, wired, optical cable, RF medium, or any suitable combination of the above.

A computer program code for executing the operations according to the present disclosure may be written in one or more programming languages or a combination thereof. The programming language includes an object-oriented programming language such as Java, Smalltalk and C++, and further includes a general procedural programming language such as “C” language or a similar programming language. The program codes may be executed entirely on a user computer, executed partially on the user computer, executed as a standalone package, executed partially on the user computer and partially on a remote computer, or executed entirely on the remote computer or a server. When the remote computer is involved, the remote computer may be connected to the user computer through any type of network, including a local area network (LAN) or a wide area network (WAN), or be connected to an external computer (e.g., connected through Internet provided by an Internet service provider).

The flowcharts and block diagrams in the accompanying drawings illustrate architectures, functions and operations that may be implemented according to the system, the method, and the computer program product of the various embodiments of the present disclosure. In this regard, each of the blocks in the flowcharts or block diagrams may represent a module, a program segment, or a code portion, the module, the program segment, or the code portion comprising one or more executable instructions for implementing specified logic functions. It should also be noted that, in some alternative implementations, the functions denoted by the blocks may occur in a sequence different from the sequences shown in the figures. For example, any two blocks presented in succession may be executed, substantially in parallel, or may sometimes be executed in a reverse sequence, depending on the function involved. It should also be noted that each block in the block diagrams and/or flowcharts as well as a combination of blocks may be implemented using a dedicated hardware-based system executing specified functions or operations, or by a combination of dedicated hardware and computer instructions.

The units involved in the embodiments of the present disclosure may be implemented by means of software or hardware. The described units may also be provided in a processor, for example, described as: a processor, comprising a receiving unit, a determining unit, a matching unit, and an outputting unit. The names of these units do not in some cases constitute a limitation to such units themselves. For example, the receiving unit may also be described as “a unit for receiving a message of requesting to enter a target user mode, the message being inputted by a first user.”

In another aspect, the present disclosure further provides a computer readable medium. The computer readable medium may be the computer readable medium included in the apparatus described in the above embodiments, or a stand-alone computer readable medium not assembled into the apparatus. The computer readable medium stores one or more programs. The one or more programs, when executed by the apparatus, cause the apparatus to: receive a message of requesting to enter a target user mode, the message being inputted by a first user; determine identity information of the first user; determine whether the target user mode matches the identity information of the first user; and select, if the target user mode matches the identity information, an operation option page matching the target user mode from a preset operation option page set, to output the operation option page.

The above description is only an explanation for the preferred embodiments of the present disclosure and the applied technical principles. It should be appreciated by those skilled in the art that the inventive scope of the present disclosure is not limited to the technical solution formed by the particular combinations of the above technical features. The inventive scope should also cover other technical solutions formed by any combinations of the above technical features or equivalent features thereof without departing from the concept of the invention, for example, technical solutions formed by replacing the features as disclosed in the present disclosure with (but not limited to) technical features with similar functions.

What is claimed is:

1. A method for outputting information, comprising:
receiving a message of requesting to enter a target user mode, the message being inputted by a first user;
determining identity information of the first user;
determining whether the target user mode matches the identity information of the first user; and
selecting, if the target user mode matches the identity information, an operation option page matching the target user mode from a preset operation option page set, to output the operation option page.

2. The method according to claim 1, further comprising:
selecting, if the target user mode does not match the identity information, an operation option page matching a user mode matching the identity information of the first user from the preset operation option page set, to output the operation option page.

3. The method according to claim 1, wherein the determining identity information of the first user comprises:
in response to receiving first voice of the first user, generating a first voiceprint characteristic vector based on the first voice; and
inputting the first voiceprint characteristic vector into a pre-trained voiceprint recognition model to obtain the identity information of the first user, the recognition model being used to represent a corresponding relationship between the voiceprint characteristic vector and the identity information of the user.

4. The method according to claim 1, wherein the determining identity information of the first user comprises:
outputting a question for verifying user identity information;
determining, in response to receiving reply information inputted by the first user, whether an answer matching the reply information is included in a predetermined answer set, the answer corresponding to the user identity information; and
determining, if the answer is included in the predetermined answer set, the user identity information corresponding to the answer matching the reply information as the identity information of the first user.

5. The method according to claim 3, wherein the generating a first voiceprint characteristic vector based on the first voice comprises:
importing the first voice into a pre-trained universal background model to perform mapping to obtain a first voiceprint characteristic super-vector, the universal background model being used to represent a corresponding relationship between voice and the voiceprint characteristic super-vector; and
performing a dimension reduction on the first voiceprint characteristic super-vector to obtain the first voiceprint characteristic vector.

6. The method according to claim 1, further comprising:
recording, in response to determining the first user belonging to a predetermined population group according to the identity information of the first user, a time point of determining the identity information of the first user as a viewing start time of the first user; and
outputting time prompting information or performing a turnoff operation, in response to determining at least one of a difference between a current time and the viewing start time of the first user being greater than a viewing duration threshold of the predetermined population group or the current time being within a predetermined time interval.

7. The method according to claim 1, wherein the identity information comprises at least one of: gender, age or family member identifier.

8. The method according to claim 7, further comprising:
in response to receiving second voice of a second user, generating a second voiceprint characteristic vector based on the second voice;
inputting the second voiceprint characteristic vector into a voiceprint recognition model to obtain identity information of the second user, the recognition model being used to represent a corresponding relationship between the voiceprint characteristic vector and the identity information of the user; and
determining a younger user from the first user and the second user, and selecting an operation option page matching a user mode corresponding to the younger user from the preset operation option page set to output the operation option page.

9. An apparatus for outputting information, comprising:
at least one processor; and
a memory storing instructions, wherein the instructions when executed by the at least one processor, cause the at least one processor to perform operations, the operations comprising:
receiving a message of requesting to enter a target user mode, the message being inputted by a first user;
determining identity information of the first user;
determining whether the target user mode matches the identity information of the first user; and
selecting, if the target user mode matches the identity information, an operation option page matching the target user mode from a preset operation option page set, to output the operation option page.

10. The apparatus according to claim 9, wherein the operations further comprise:
selecting, if the target user mode does not match the identity information, an operation option page matching a user mode matching the identity information of the first user from the preset operation option page set, to output the operation option page.

11. The apparatus according to claim 9, wherein the determining identity information of the first user comprises:
generating, in response to receiving first voice of the first user, a first voiceprint characteristic vector based on the first voice; and
inputting the first voiceprint characteristic vector into a pre-trained voiceprint recognition model to obtain the identity information of the first user, the recognition model being used to represent a corresponding relationship between the voiceprint characteristic vector and the identity information of the user.

12. The apparatus according to claim 9, wherein the determining identity information of the first user comprises:
outputting a question for verifying user identity information;
determining, in response to receiving reply information inputted by the first user, whether an answer matching the reply information is included in a predetermined answer set, the answer corresponding to the user identity information; and
determining, if the answer is included in the predetermined answer set, the user identity information corresponding to the answer matching the reply information as the identity information of the first user.

13. The apparatus according to claim 11, wherein the generating a first voiceprint characteristic vector based on the first voice comprises:
importing the first voice into a pre-trained universal background model to perform mapping to obtain a first voiceprint characteristic super-vector, the universal background model being used to represent a corresponding relationship between voice and the voiceprint characteristic super-vector; and
performing a dimension reduction on the first voiceprint characteristic super-vector to obtain the first voiceprint characteristic vector.

14. The apparatus according to claim 9, wherein the operations further comprise:
recording, in response to determining the first user belonging to a predetermined population group according to the identity information of the first user, a time point of determining the identity information of the first user as a viewing start time of the first user; and
outputting time prompting information or performing a turnoff operation, in response to determining at lease one of a difference between a current time and the viewing start time of the first user being greater than a viewing duration threshold of the predetermined population group or the current time being within a predetermined time interval.

15. The apparatus according to claim 9, wherein the identity information comprises at least one of: gender, age or family member identifier.

16. The apparatus according to claim 15, wherein the operations further comprise:
generating, in response to receiving second voice of a second user, a second voiceprint characteristic vector based on the second voice;
inputting the second voiceprint characteristic vector into a voiceprint recognition model to obtain identity information of the second user, the recognition model being used to represent a corresponding relationship between the voiceprint characteristic vector and the identity information of the user; and
determining a younger user from the first user and the second user, and selecting an operation option page matching a user mode corresponding to the younger user from the preset operation option page set to output the operation option page.

17. A non-transitory computer readable medium, storing a computer program, wherein the program, when executed by a processor, causes the processor to perform operations, the operations comprising:
receiving a message of requesting to enter a target user mode, the message being inputted by a first user;
determining identity information of the first user;
determining whether the target user mode matches the identity information of the first user; and
selecting, if the target user mode matches the identity information, an operation option page matching the target user mode from a preset operation option page set, to output the operation option page.
